(19) United States
(12) Patent Application Publication
(10) Pub. No.: US 2026/0122148 A1
(43) Pub. Date: Apr. 30, 2026

(54) FLEXIBLE FRAMING FOR FRONTHAUL

(71) Applicant: Telefonaktiebolaget LM Ericsson (publ), Stockholm (SE)

(72) Inventors: Davide SANGUINETTI, Genova (IT); Fabrizio STEFANELLI, Genova (IT); Roberto PACCHETTI, Genova (IT)

(73) Assignee: Telefonaktiebolaget LM Ericsson (publ), Stockholm (SE)

(21) Appl. No.: 19/116,707

(22) PCT Filed: Sep. 29, 2023
(86) PCT No.: PCT/EP2023/077137

§ 371 Date: Mar. 28, 2025

Related U.S. Application Data
(60) Provisional application No. 63/411,854, filed on Sep. 30, 2022.

(51) Int. Cl. H04L 69/08; H04L 69/04

(52) U.S. Cl. CPC H04L 69/08; H04L 69/04

(57) ABSTRACT

A transmitting node can determine client data to be transmitted to a receiving node. The client data can be associated to a client. The transmitting node can determine a difference between a data rate of the client data and a portion of a total line rate. The total line rate can be associated with a line between the transmitting node and the receiving node. The portion of the total line rate can be associated with the client. The transmitting node can generate a transmission signal by adding information to the client data. An amount of the information can be based on the difference between the data rate and the portion of the total line rate. The transmitting node can transmit the transmission signal to the receiving node via the line.

### TECHNICAL FIELD

The present disclosure is related to wireless communication systems and more particularly to flexible framing for fronthaul.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

The use of Dense Wavelength Division Multiplexing (“DWDM”) optical transport for Common Public Radio Interface (“CPRI”) (or enhanced CPRI (“eCPRI”)) clients allow the reduction of the number of optical fibers to be used to interconnect the network nodes. An agnostic optical transport for CPRI and other types of clients will allow an easy way to merge the transport network for radio front-haul and backhaul of fixed and mobile access networks.

### SUMMARY

According to some embodiments, a method of operating a transmitting node is provided. The method includes determining client data to be transmitted to a receiving node, the client data associated to a client. The method further includes determining a difference between a data rate of the client data and a portion of a total line rate. The total line rate is associated with a line between the transmitting node and the receiving node. The portion of the total line rate is associated with the client. The method further includes generating a transmission signal by adding information to the client data. An amount of the information is based on the difference between the data rate and the portion of the total line rate. The method further includes transmitting the transmission signal to the receiving node via the line.

According to other embodiments, a method of operating a receiving node is provided. The method includes receiving a received signal from a transmitting node via a line between the transmitting node and the receiving node. The method further includes extracting information from the received signal. The method further includes determining client data from the received signal. The client data is separate from the information. The method further includes providing the client data to an associated client.

According to other embodiments, a transmitting node, a receiving node, a computer program, a computer program product, a non-transitory computer-readable medium, a host, or a communications system is provided to perform one of the methods above.

Certain embodiments may provide one or more of the following technical advantages. In some embodiments, re-use of same encoding and decoding blocks (e.g., 66B, Reed Soloman Forward Error Correction (“RS-FEC”)) of clients can reduce design complexity and add flexibility (e.g., ports can be configured as clients or lines).

In additional or alternative embodiments, direct mapping of client data on timeslots and proprietary idle sequences are used to adapt the client rate to the line rate. In some examples, the line rate can be the same or a higher than the client rate, which avoids the use of dedicated optical modules.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram illustrating an example of a 5G network;

FIGS. 2A-B are block diagrams illustrating examples of terminal-to-terminal communication networks in accordance with some embodiments;

FIG. 3 is a block diagram illustrating an example of architecture for a flexible framing for a fronthaul in accordance with some embodiments;

FIG. 4 is a block diagram illustrating an example of a framing structure in accordance with some embodiments;

FIG. 5 is a block diagram illustrating Agnostic Transport for Fronthaul (“ATF”) 25 sequence examples in accordance with some embodiments;

FIG. 6 is a table illustrating an example of client data rates in accordance with some embodiments;

FIG. 7 is a block diagram of an Ethernet frame in accordance with some embodiments;

FIG. 8 is a block diagram illustrating an example of an Ethernet frame start compression in accordance with some embodiments;

FIG. 9 is a block diagram illustrating an example of an Ethernet idle compression in accordance with some embodiments;

FIG. 10 is a block diagram illustrating an example of an Ethernet sequence and error compression in accordance with some embodiments;

FIG. 11 is a table illustrating an example of control codes in accordance with some embodiments;

FIG. 12 is a block diagram illustrating an example of timeslot assignment for three clients multiplexed over two lines in accordance with some embodiments;

FIG. 13 is a block diagram illustrating an example of timeslot assignment for one client over one line in accordance with some embodiments;

FIG. 14 is a schematic diagram illustrating an example of ATF25 framing of a single client with compression in accordance with some embodiments;

FIG. 15 is a flow chart illustrating an example of operations performed by a transmitting node in accordance with some embodiments;

FIG. 16 is a flow chart illustrating an example of operations performed by a transmitting node in accordance with some embodiments;

FIG. 17 is a block diagram of a communication system in accordance with some embodiments;

FIG. 18 is a block diagram of a user equipment in accordance with some embodiments;

FIG. 19 is a block diagram of a network node in accordance with some embodiments;

FIG. 20 is a block diagram of a host, which may be an embodiment of the host of FIG. 17, in accordance with some embodiments;

FIG. 21 is a block diagram of a virtualization environment in accordance with some embodiments; and

FIG. 22 shows a communication diagram of a host communicating via a network node with a user equipment over a partially wireless connection in accordance with some embodiments.

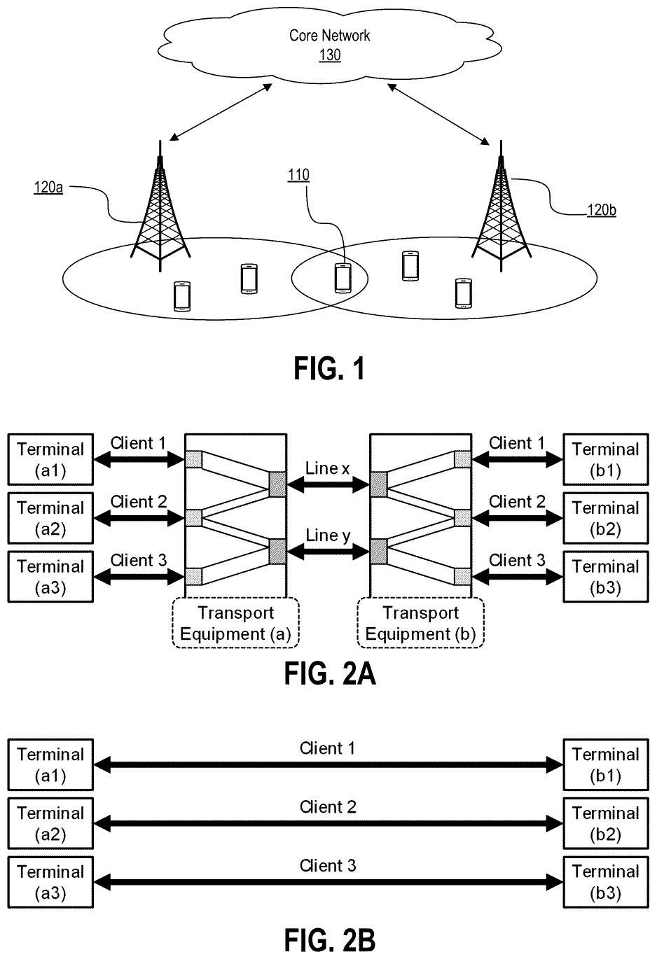

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

There currently exist certain challenges. Flexible Ethernet (“FlexE”) can multiplex Ethernet clients using timeslots, but is limited to Ethernet rates and cannot forward client rate offset. It cannot multiplex other client types unless they are mapped on Ethernet in advance. Ethernet switching does not guarantee the low latency required by eCPRI and cannot manage CPRI or other client types. Proprietary Agnostic Transport for Fronthaul (“ATF11”) framing has a bandwidth overhead (e.g., 25 Gb/s), which is a problem since Optical modules at this rate accept only standard rates.

Certain aspects of the disclosure and their embodiments may provide solutions to these or other challenges. Various embodiments herein describe time division multiplexing of clients over an agnostic line framing. In some embodiments, clients are mapped almost transparently to have an end-to-end transport like just a delay of the signal. In some examples, client frequency is maintained, latency is deterministic, and Loss Of Signal from the client is propagated.

In some embodiments, in respect to ATF11, the line data rate can be the same as Ethernet clients, avoiding bandwidth penalty. In additional or alternative embodiments, a physical coding layer can reuse the same standard encoding/decoding blocks of clients.

In additional or alternative embodiments, flexible framing using a same encoding and decoding blocks (e.g., 66B, RS-FEC) of clients are able to transparently map and multiplex clients maintaining a deterministic delay and frequency. In additional or alternative embodiments, clients can be automatically recognized, decoded, and mapped. In some examples, an Ethernet client compression can be used to avoid a bandwidth penalty and to have room for an in-band service channel between a local Fronthaul and a remote Fronthaul.

In additional or alternative embodiments, special codes can be used to have frame alignment sequences including useful information to be exchanged between peers. In some examples, the special codes can be used without modifying the client data.

In additional or alternative embodiments, the frames are divided into timeslots, and each one can be allocated to a different client. In some examples, when client data is not available (empty buffer) on the timeslot, a special “idle” code is sent including side information that can be used to exchange other information to the remote side, for example, an in-band service channel.

FIGS. 2A-B illustrate examples of multiplexing of three clients over two lines.

In FIG. 2A, two transport equipment (a, b) connect three terminals (a1, a2, a3) to three terminals (b1, b2, b3) trying to be transparent, as if the three terminals are directly connected as in FIG. 2B. The transport equipment can include any suitable networks (e.g., radio access network (“RAN”) node or core network (“CN”) node) or fronthaul (e.g., connecting terminals which are a Remote Radio Unit (“RRU”) and a Baseband Unit (“BBU”)). The terminals can include any suitable communication devices and/or network nodes. In some examples, the transport equipment is co-located with one or more of the associated terminals. For example, transport equipment (a) can be co-located with terminal (a1). In other examples, the transport equipment (a) is at a separate location from the terminals.

In FIG. 2A, client 2 is shared between two lines (x and y), which also carry client 1 and client 3 respectively. To do this they have to quickly adapt to changes of behavior of the terminals, including both rate changes and optical module switch on/off. The client status on the receive side is forwarded over the line using overhead data and extracted on the other side to correctly de-map client data on the transmit side.

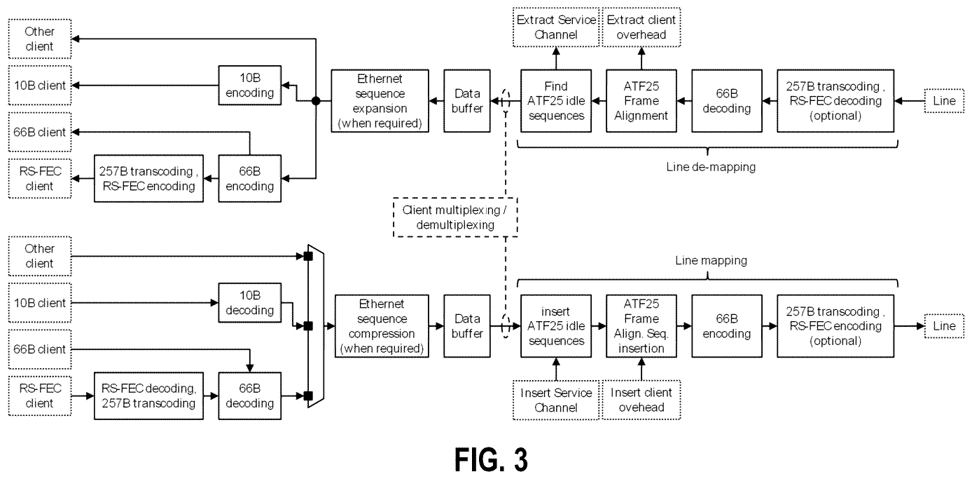

FIG. 3 illustrates an example of a framing and mapping process performed by transport equipment to provide flexible framing for fronthaul. On the left there is the client processing. Depending on client type, the data is sent to the framer transparently or with some physical coding layer (“PCS”) processing. In some examples, the method and apparatus are implemented in the Physical layer (“PHY”), for example, in the PCS layer. The examples may be implemented or associated with nodes of a radio access network (e.g., in or connected to a RRU and DU).

The client multiplexing allows clients to be grouped and to be sent to the same line, or split clients over multiple lines. In this example, data from different lines must be aligned by using buffers and frame alignment words as reference. This is possible since all the lines transmit with same phase and frequency so that frame alignment words are transmitted at the same time for all lines.

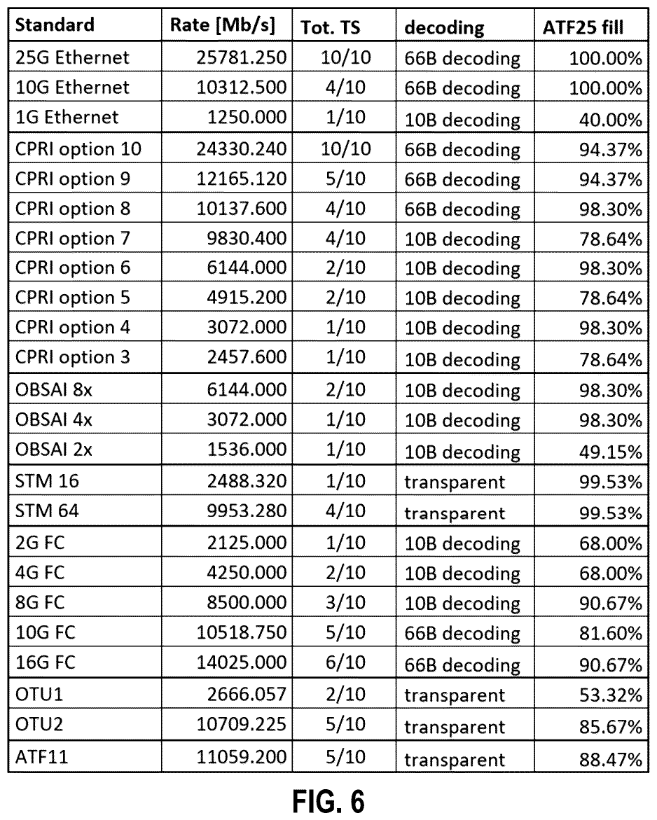

In some examples, the client data rate is equal to the line rate (e.g., a transmission rate or a number of allocated resources on the transmission). This means that there is no time or physical resources in which to transmit additional overhead or control signaling. In additional or alternative examples, the client data can be compressed in order to make room (e.g., physical resources on the transmission) to insert overhead information or control signaling information. For example, in regards to Ethernet clients, sequences at frame start or idle can be compressed. In this way, room can be created to add line overhead information and to do asynchronous mapping when the line rate equals the client rate. As a result, the timing of the transmission of the client data is not affected by the insertion of overhead information, even when the client data rate is equal to the line rate. In some aspects, for a ATF25 example when no compression is possible (e.g., CPRI clients) client rate is always less than line rate. (See table in FIG. 6). The only clients that need compression are Ethernet, so mapping inserted information is always possible.

FIG. 3 illustrates a receiver (upper image) and transmitter (lower image). The transmitter and receiver functions are substantially symmetrical for transmission and reception of user data with an inserted/extracted overhead.

From a perspective of the transmitter, in some embodiments, the client data may be compressed (e.g., via Ethernet sequence compression). In additional or alternative embodiments, in case of clients with other PCS, coding data is mapped transparently. For example, 64 bits of client data are mapped on a data-only 66B word.

Client data may be from one or more different types of client (e.g., a 10B client, 66B client, RS-FEC client, or other client). For some client data, a decoding process is carried out. For example, for a 10B client a 10B decoding is carried out; for a 66B client, 66B decoding is carried out; for a RS-FEC client, RS-FEC decoding, 257B transcoding and 66B decoding is carried out. In some examples, one or more clients, of one or more types of client data, are multiplexed. In additional or alternative embodiments, in case of clients with other PCS, coding data is mapped transparently. For example, 64 bits of client data are mapped on a data-only 66B word.

In some embodiments, the data is compressed (e.g., via Ethernet sequence compression). This may be required if the client data rate has the same demultiplexed frame (line) rate. The compression is carried out per client, the overhead insertion is carried out per line, exploiting the “empty” timeslots created by the compression. The frames are divided into timeslots, and each one can be allocated to a different client. References to the line rate may refer to the portion of the line rate assigned to the client. For example, if a client is allocated 4 timeslots out of 10, the available rate for the client is 0.4*total line rate. The compression (e.g., via Ethernet sequence compression) generates unused physical resources (e.g. timeslots) which can be used to carry overhead or service channel signaling. As such, the compressed client has a data rate which has an amount of difference from the line rate allocated to that client. The difference (e.g., time resources unused by the compressed client data) is used to carry an amount of overhead or service channel signaling which does not exceed the line rate.

Following compression, the client data may optionally be buffered and mapped to a line, multiplexing clients if applicable. The line mapping comprises insertion of service channel information and/or client overhead in place of identified idle sequences and/or frame alignment sequences. In some examples, the identified idle sequences and/or frame alignment sequences are replaced with shorter identifiers, e.g. reserved characters, which creates unused time resources. In some aspects, the service channel and/or client overhead may be inserted in any available resources, the insertion of service channel overhead information is not limited to the example shown. Following service channel and/or client overhead insertion, the line may be encoded e.g. with 66B encoding, and optionally transcoded e.g. 257B transcoding, and optionally RS-FEC encoding. The multiplexed and compressed client data, with inserted service channel and/or overhead, is then transmitted on the line, e.g. an optical line.

From a perspective of the receiver, client data may be intended for one or more different types of client (e.g., a 10B client, 66B client, RS-FEC client, or other client) is received. The transmission process is reversed, with the line de-mapped and the service channel and/or overhead extracted. The client data is decompressed (e.g., by identifying the location and identity of the replaced sequences, for example, idle sequences and/or frame alignment sequences, for example, as marked by a special inserted character. The replaced sequences, for example, idle sequences and/or frame alignment sequences, are inserted back into the client data. The decompressed client data is then identical to the original client data, and so the compression process is transparent (i.e. not visible) to higher layers (e.g., above the Physical layer, e.g. the PCS layer).

For some client data, an encoding process is carried out. For example, for a 10B client a 10B encoding is carried out; for a 66B client, 66B encoding is carried out; for a RS-FEC client, RS-FEC encoding, 257B transcoding and 66B encoding is carried out. In some examples, one or more clients, of one or more types of client data, are demultiplexed. In some embodiments, the data is decompressed/expanded (e.g., Ethernet sequence expansion).

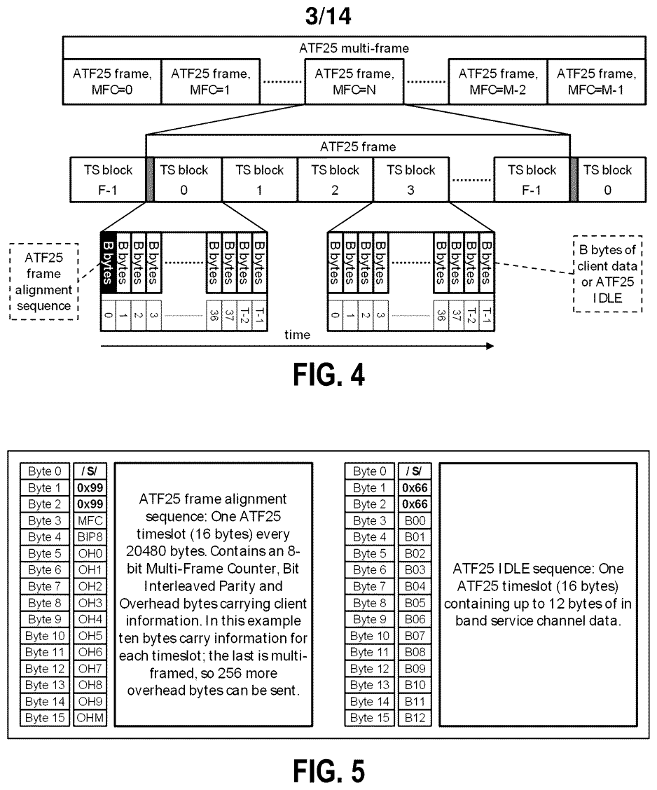

In the example illustrated in FIG. 3 (on the right) client data is assigned to timeslots and mapped; then is coded with standard blocks as illustrated in FIG. 4.

The name ATF25 derives from the acronym Agnostic Transport for Fronthaul and 25 is the net data rate, Gb/s. In some examples, ATF25 frames include B-bytes timeslots (multiple of 8 to allow 66B coding). The number of timeslots is T. Each ATF25 frame is composed by F blocks, T timeslot each. The first timeslot of each ATF25 frame contains a special Frame Alignment Word with overhead containing client information. The overhead contained on Frame Alignment Word may contain a multi-frame counter, enabling more overhead information to be carried. M frames for a multi-frame.

In this example the parameters are: B=16 bytes; T=10 timeslots; F=2048 blocks; M=256; ATF frame length is 327680 bytes; and rate loss on timeslot zero due to Frame Alignment Word is 48.8 PPM. Each timeslot is aligned and is a multiple of a 66B block. The line coding uses the same encoding used in client such as Ethernet and CPRI. More detail on the 64B/66B transmission code can be found in IEEE std 802.3-2018, clause 49.2.4. Each byte can be a data byte or a special character; with this encoding method 8 bytes are encoded into 66 bits, with a low overhead of 3.125%.

In some examples, Forward Error Correction can be added to 66B coded data, again re-using Ethernet and CPRI standards. With 25 Gb/s interfaces, this is required due to the characteristics of the optical modules.

Another requirement of the optical modules at this rate is the need to use standard frequencies, due to the internal retimers. For this reason, a compression method can be applied to the client to allow its mapping on the line as illustrated in FIG. 5. Specifically, FIG. 5 illustrates examples of coding for ATF25 sequences. Both use/S/special character but followed by data bytes not conventionally used, e.g. on Ethernet and CPRI channels. The left portion of FIG. 5 illustrates an example of a ATF25 frame alignment sequence. The ATF25 frame alignment sequence includes one ATF25 timeslot (comprising 16 bytes) every 20480 bytes. The ATF25 frame alignment sequence further includes an 8-bit Multi-Frame Counter, Bit Interleaved Parity, and Overhead bytes including client information. In this example, ten bytes include information for each timeslot. The last byte is multiframed so 256 more overhead bytes can be sent. As such, the conventional ATF25 frame alignment sequence timeslot (16 bytes) is modified, e.g. by used of one or more reserved character, to require less bytes. The remaining bytes, e.g. Byte 5 to Byte 14 are used to carry further information, e.g. overhead bytes, e.g. OH0 to OH9. The right portion of FIG. 5 illustrates an example of an ATF25 idle sequence. The ATF25 idle sequence includes one ATF25 timeslot (comprising 16 bytes) including up to 12 bytes of in-band service channel data. As such, the conventional ATF25 idle sequence timeslot (16 bytes) is modified, e.g. by used of one or more reserved character, to require less bytes. The remaining bytes, e.g. Byte 3 to Byte 15 are used to carry further information, e.g. service channel data, e.g. B00 to B12. FIG. 6 is a table illustrating an example of client data rates. As illustrated, several possible clients can be mapped on a 25 Gb/s line. In this example, the nominal rate of the line is 25 Gb/s and there are 10 timeslots, 2.5 Gb/s each. The third column indicates how many timeslots are required to map each client. The fifth column indicates how much bandwidth is required on the timeslots to carry the client.

In this example, the 25G Ethernet client on first line has the same nominal rate of the ATF25 line, so compression can be used to allow the mapping.

As indicated by the second line, the 10G Ethernet client has the same nominal rate of the ATF25 line when 4 timeslots out of 10 are used.

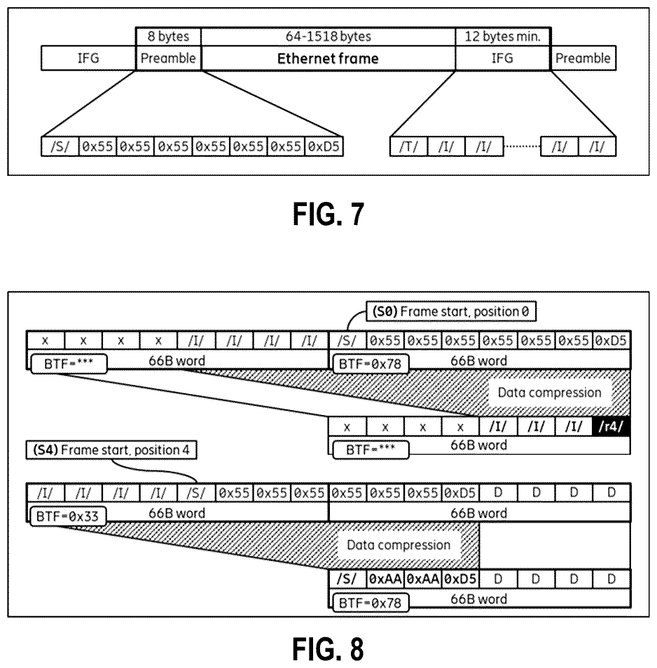

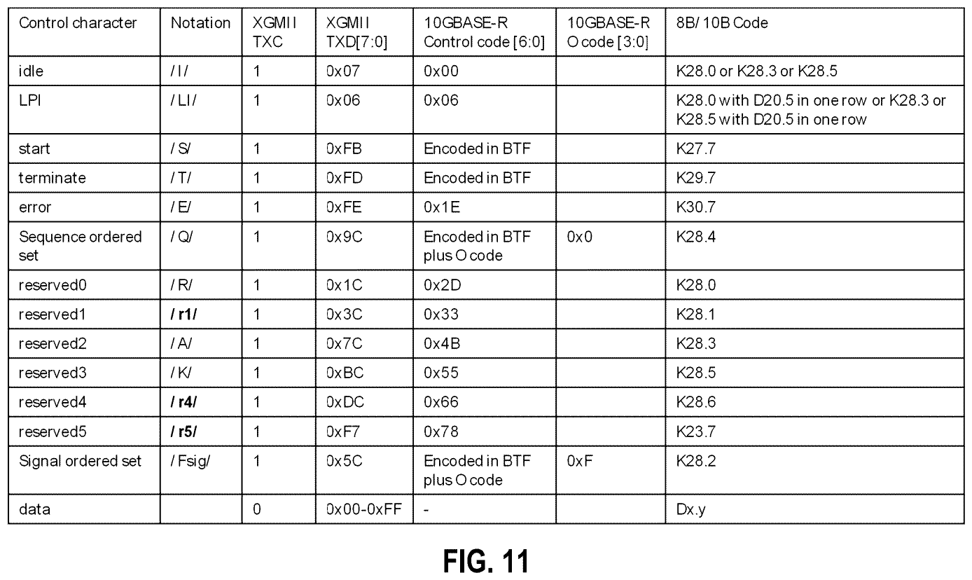

FIG. 7 illustrates an example of an Ethernet frame. As illustrated, Ethernet frames are sent with a frame preamble and idles (which can allow for data compression). An Ethernet frame preamble is 8 bytes, and an inter-frame gap (“IFG”) is at least 12 bytes. Maximum length for a standard Ethernet frame is 1518 bytes. Some of the control codes defined in FIG. 11 are never used on CPRI or Ethernet clients.

FIGS. 8-10 illustrate compression examples and are described below.

FIG. 8 illustrates an example of Ethernet frame start compression. In the Ethernet standard, when using 66B coding, Frame start can happen on two positions only: on byte 0 or byte 4. Before frame start (/s/) there are always idle (/I/) bytes. After start, there is always the frame preamble (6 data bytes, all 55 hex) and then the delimiter (one data byte, D5 hex). In total, there are 12 bytes indicating that a frame is beginning. The sequence can be compressed without losing information. In this example, the sequence can be compressed from 12 bytes to 4 bytes. The resulting 16-byte sequence can never be found on client data stream. Therefore, when demapping, ATF25 data is always possible to reconstruct the original client data stream.

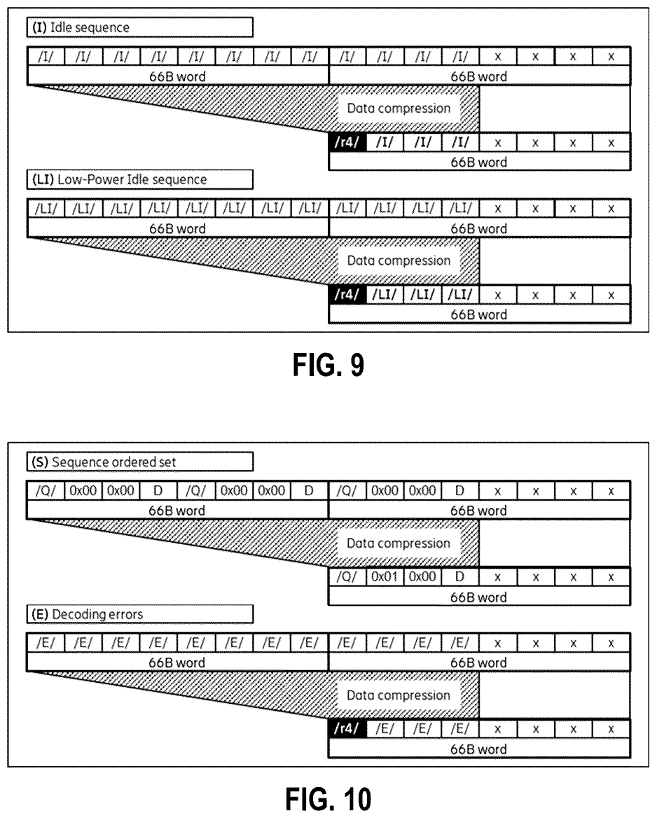

FIG. 9 illustrates an example of Ethernet idle compression. In this example, 12 consecutive bytes of idle (/I/) or Low Power Idle (/LI/) can be replaced with a 4-byte sequence. The resulting 16-byte sequence can never be found on a client data stream, so when demapping ATF25 data it is always possible to reconstruct the original client data stream.

FIG. 10 illustrates an example of Ethernet sequence and error compression. In this examples, a sequence ordered set is a repeating sequence (e.g., special code/Q/, data bytes 00 00, and then a fourth byte containing information). 3×4 bytes can be compressed into a 4-byte sequence without losing information. A similar process can be performed for repeating error (/E/) sequences.

Byte/r4/is the control character reserved4 found in FIG. 11. Bytes marked as “x” are don't care. BTF stands for Block Type Field, as found on IEEE std 802.3-2018, FIG. 49-7.

The worst case for data compression is when receiving Ethernet frames at maximum length, 100% rate. It's possible to save at least 8 bytes (as illustrated in FIG. 8) for each frame. The frame sequence length is preamble+frame+IFG=1538 bytes (as illustrated in FIG. 7). Rate saving is:

$$\frac{8}{1538} \approx 0.0052 ,$$

which is roughly 5200 PPM saved. Considering a client offset of +100 PPM and the rate loss due to Frame Alignment Word (48.8 PPM) it's still 5051 PPM saved. At 25 Gb/s this is about 126 Mb/s. This is a worst case; when frame rate is not 100% or frames have other lengths the saving is higher.

When no client data is ready to be sent on a timeslot, the proprietary ATF25 IDLE sequence is sent instead (see FIG. 5, right). The available data bytes can be used to exchange data with the remote transport equipment, such as a service channel. On this example the available bandwidth is at least 100 Mb/s, enough to transport a fast Ethernet channel.

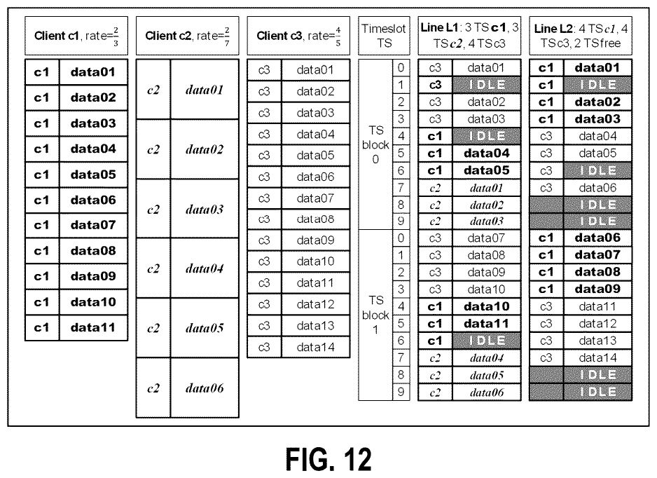

FIG. 12 illustrates an example of timeslot assignment for three clients multiplexed over two lines. In this example, line rate is 1 and the available rate for the three clients is 2 (2 lines). Accordingly the total rate for clients is approximately 1.752 (2/3+2/7+4/5). Client C1 is sent on timeslot 4-6 of line L1 and timeslot 0-3 of line L2 (a total of 7 timeslots out of 10). Since 7/10>2/3, the assigned bandwidth is enough. Client C2 is sent on timeslots 7-9 of line L1 (a total of 3 timeslots out of 10). Since 3/10>2/7, the assigned bandwidth is enough. Client C3 is sent on timeslots 0-3 of line L1 and timeslots 4-7 of line L2 (a total of 8 timeslots out of 10). Since 8/10=4/5, the assigned bandwidth is enough.

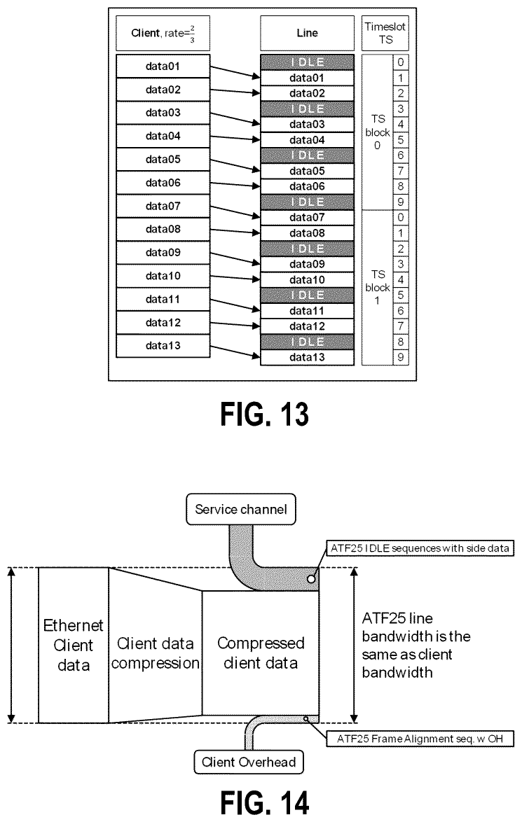

FIG. 13 illustrates an example of timeslot assignment for one client over one line. In this example, the line rate is 1 and the client rate is 2/3. All 10 timeslots are available for the client. When no client data is available the timeslot is filled with the special IDLE sequence including service channel information.

FIG. 14 illustrates an example of framing (e.g., ATF25) of a single client with compression. As illustrated, Ethernet client data can be compressed to provide space for service channel information and client overhead information, for example, using one or more of the compression examples described above. ATF25 line bandwidth (which is the same as the client bandwidth) can include the compressed client data, and inserted service channel information, and client overhead information.

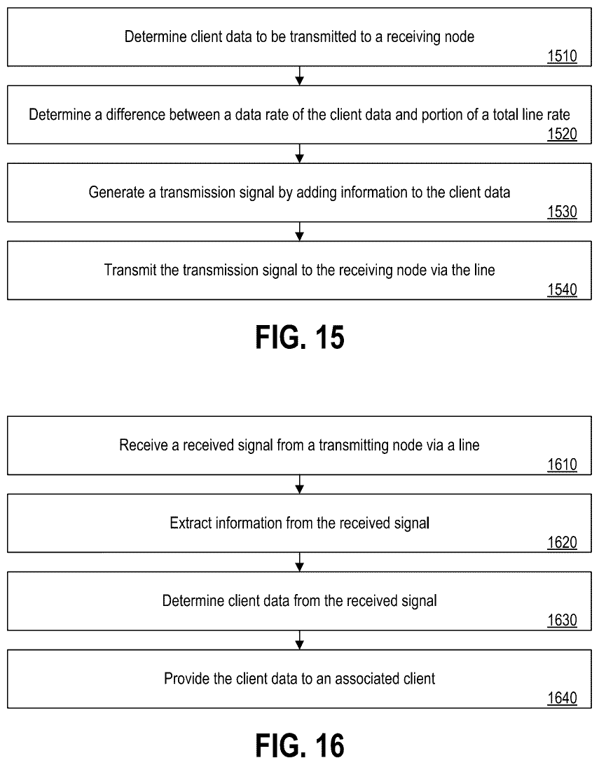

Operations of the RAN node 1900 (implemented using the structure of FIG. 19) will now be discussed with reference to the flow charts of FIGS. 15-16 according to some embodiments of inventive concepts. For example, modules may be stored in memory 1904 of FIG. 19, and these modules may provide instructions so that when the instructions of a module are executed by respective RAN node processing circuitry 1820, RAN node 1900 performs respective operations of the flow charts.

FIG. 15 illustrates an example of operations performed by a transmitting node.

At block 1510, processing circuitry 1902 determines client data to be transmitted to a receiving node. The client data is associated to a client. In some embodiments, determining the client data includes compressing the client data. In some examples, compressing the client data includes performing Ethernet sequence compression to the client data. Performing the Ethernet sequence compression can include compressing at least one of: a frame start indicator of the client data; an idle frame of the client data; a sequence ordered set of the client data; and a repeating error sequence of the client data.

In additional or alternative embodiments, the client data includes at least one of: an Ethernet client; a CPRI client; an open base station architecture initiative (“OBSAI”) client; a synchronous transfer mode (“STM”) client; a fiber channel (“FC”) client; an optical transport unit (“OTU”) client; and an ATF client.

In additional or alternative embodiments, the client data includes a plurality of client data multiplexed together.

At block 1520, processing circuitry 1902 determines a difference between a data rate of the client data and a portion of a total line rate. The total line rate can be associated with a line between the transmitting node and the receiving node. The portion of the total line rate can be associated with the client.

At block 1530, processing circuitry 1902 generates a transmission signal by adding information to the client data. An amount of the information is based on the difference between the data rate and the portion of the total line rate. In some embodiments, the information includes service channel information or overhead information. In additional or alternative embodiments, the amount of the information is less than or equal to the difference between the data rate and the portion of the total line rate.

In some aspects, based on the difference between the data rate and the portion of the total line rate comprises adding a same or less information to the client data than was removed by the compression. As such, the (compressed) client data and inserted information has a data rate which is less than or equal to the uncompressed data rate or line rate. Thus, the amount of information which can be inserted is based on the difference between the client data (e.g., compressed client data) and the line rate for that client, since the difference sets a maximum amount of information which can be inserted. For multiple clients, the amount of information which can be inserted is based on all of the client data and the total line rate.

In additional or alternative embodiments, generating the transmission signal includes: framing the client data; assigning client data to timeslots; and adding the information in empty timeslots.

In additional or alternative embodiments, generating the transmission signal includes mapping 64 bits of client data on a data-only 66 Byte word.

At block 1540, processing circuitry 1902 transmits, via communication interface 1906, the transmission signal to the receiving node via the line.

FIG. 16 illustrates an example of operations performed by a receiving node.

At block 1610, processing circuitry 1902 receives, via communication interface 1906, a received signal from a transmitting node via a line between the transmitting node and the receiving node. In some embodiments, the received signal includes an ATF25 encoded signal.

At block 1620, processing circuitry 1902 extracts information from the receiving signal. In some embodiments, the information includes service channel information or overhead information.

At block 1630, processing circuitry 1902 determines client data from the received signal, the client data being separate from the information. In some embodiments, determining the client data includes decompressing the received signal. In some examples, decompressing the received signal includes performing Ethernet sequence expansion to the received signal.

In some embodiments, the client data includes at least one of: an Ethernet client; a CPRI client; an OBSAI client; a STM client; a FC client; an OTU client; and an ATF client.

In additional or alternative embodiments, determining the client data includes demapping 64 bits of client data from a data-only 66 Byte word.

At block 1640, processing circuitry 1902 provides, via communication interface 1906, the client data to an associated client. In some embodiments, the client data is associated with a plurality of different clients.

Various operations from the flow charts of FIGS. 15-16 may be optional with respect to some embodiments of communication devices and related methods.

Although FIGS. 15-16 are described in regards to RAN node 1900, similar operations can be performed by any suitable network node, for example, CN node 1900. For example, modules may be stored in memory 1904 of FIG. 19, and these modules may provide instructions so that when the instructions of a module are executed by respective CN node processing circuitry 1902, CN node 1900 performs respective operations of the flow charts.

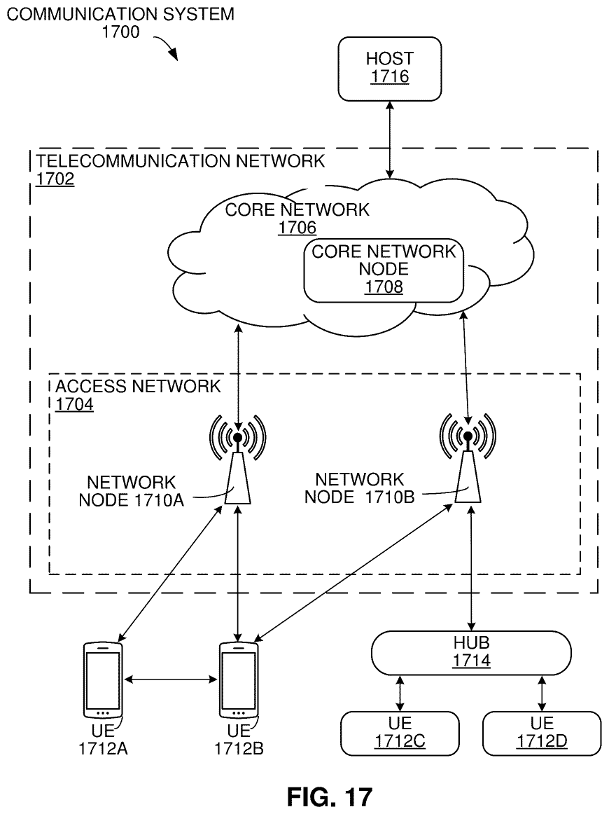

FIG. 17 shows an example of a communication system 1700 in accordance with some embodiments.

In the example, the communication system 1700 includes a telecommunication network 1702 that includes an access network 1704, such as a radio access network (RAN), and a core network 1706, which includes one or more core network nodes 1708. The access network 1704 includes one or more access network nodes, such as network nodes 1710a and 1710b (one or more of which may be generally referred to as network nodes 1710), or any other similar 3rd Generation Partnership Project (3GPP) access node or non-3GPP access point. The network nodes 1710 facilitate direct or indirect connection of user equipment (UE), such as by connecting UEs 1712a, 1712b, 1712c, and 1712d (one or more of which may be generally referred to as UEs 1712) to the core network 1706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1700 may include any number of wired or wireless networks, network nodes, UEs, and/or any other components or systems that may facilitate or participate in the communication of data and/or signals whether via wired or wireless connections. The communication system 1700 may include and/or interface with any type of communication, telecommunication, data, cellular, radio network, and/or other similar type of system.

The UEs 1712 may be any of a wide variety of communication devices, including wireless devices arranged, configured, and/or operable to communicate wirelessly with the network nodes 1710 and other communication devices. Similarly, the network nodes 1710 are arranged, capable, configured, and/or operable to communicate directly or indirectly with the UEs 1712 and/or with other network nodes or equipment in the telecommunication network 1702 to enable and/or provide network access, such as wireless network access, and/or to perform other functions, such as administration in the telecommunication network 1702. In the depicted example, the core network 1706 connects the network nodes 1710 to one or more hosts, such as host 1716. These connections may be direct or indirect via one or more intermediary networks or devices. In other examples, network nodes may be directly coupled to hosts. The core network 1706 includes one more core network nodes (e.g., core network node 1708) that are structured with hardware and software components. Features of these components may be substantially similar to those described with respect to the UEs, network nodes, and/or hosts, such that the descriptions thereof are generally applicable to the corresponding components of the core network node 1708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1716 may be under the ownership or control of a service provider other than an operator or provider of the access network 1704 and/or the telecommunication network 1702, and may be operated by the service provider or on behalf of the service provider. The host 1716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1700 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1702 is a cellular network that implements 3GPP standardized features. Accordingly, the telecommunications network 1702 may support network slicing to provide different logical networks to different devices that are connected to the telecommunication network 1702. For example, the telecommunications network 1702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1712 are configured to transmit and/or receive information without direct human interaction. For instance, a UE may be designed to transmit information to the access network 1704 on a predetermined schedule, when triggered by an internal or external event, or in response to requests from the access network 1704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1714 communicates with the access network 1704 to facilitate indirect communication between one or more UEs (e.g., UE 1712c and/or 1712d) and network nodes (e.g., network node 1710b). In some examples, the hub 1714 may be a controller, router, content source and analytics, or any of the other communication devices described herein regarding UEs. For example, the hub 1714 may be a broadband router enabling access to the core network 1706 for the UEs. As another example, the hub 1714 may be a controller that sends commands or instructions to one or more actuators in the UEs. Commands or instructions may be received from the UEs, network nodes 1710, or by executable code, script, process, or other instructions in the hub 1714. As another example, the hub 1714 may be a data collector that acts as temporary storage for UE data and, in some embodiments, may perform analysis or other processing of the data. As another example, the hub 1714 may be a content source. For example, for a UE that is a VR headset, display, loudspeaker or other media delivery device, the hub 1714 may retrieve VR assets, video, audio, or other media or data related to sensory information via a network node, which the hub 1714 then provides to the UE either directly, after performing local processing, and/or after adding additional local content. In still another example, the hub 1714 acts as a proxy server or orchestrator for the UEs, in particular if one or more of the UEs are low energy IoT devices.

The hub 1714 may have a constant/persistent or intermittent connection to the network node 1710b. The hub 1714 may also allow for a different communication scheme and/or schedule between the hub 1714 and UEs (e.g., UE 1712c and/or 1712d), and between the hub 1714 and the core network 1706. In other examples, the hub 1714 is connected to the core network 1706 and/or one or more UEs via a wired connection. Moreover, the hub 1714 may be configured to connect to an M2M service provider over the access network 1704 and/or to another UE over a direct connection. In some scenarios, UEs may establish a wireless connection with the network nodes 1710 while still connected via the hub 1714 via a wired or wireless connection. In some embodiments, the hub 1714 may be a dedicated hub—that is, a hub whose primary function is to route communications to/from the UEs from/to the network node 1710b. In other embodiments, the hub 1714 may be a non-dedicated hub—that is, a device which is capable of operating to route communications between the UEs and network node 1710b, but which is additionally capable of operating as a communication start and/or end point for certain data channels.

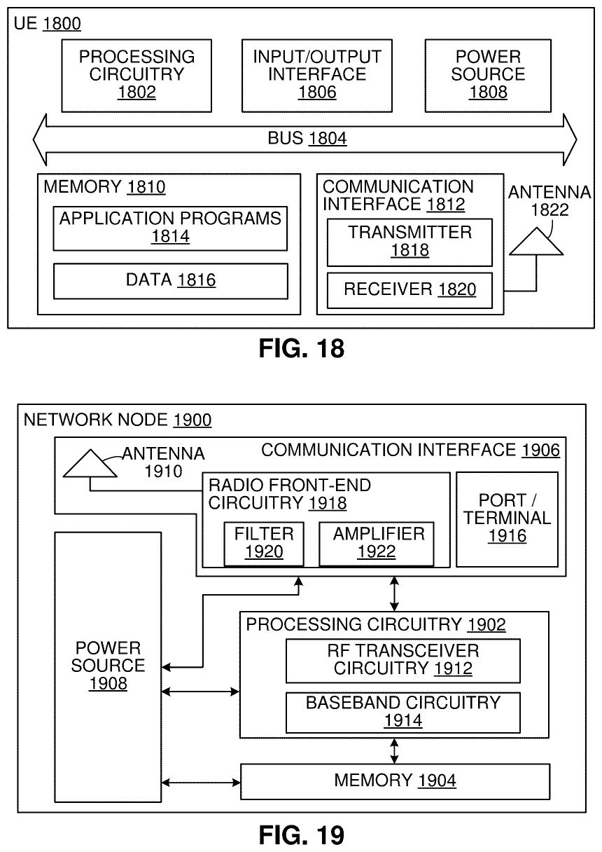

FIG. 18 shows a UE 1800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1800 includes processing circuitry 1802 that is operatively coupled via a bus 1804 to an input/output interface 1806, a power source 1808, a memory 1810, a communication interface 1812, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

The processing circuitry 1802 is configured to process instructions and data and may be configured to implement any sequential state machine operative to execute instructions stored as machine-readable computer programs in the memory 1810. The processing circuitry 1802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1802 may include multiple central processing units (CPUs).

In the example, the input/output interface 1806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1808 is structured as a battery or battery pack. Other types of power sources, such as an external power source (e.g., an electricity outlet), photovoltaic device, or power cell, may be used. The power source 1808 may further include power circuitry for delivering power from the power source 1808 itself, and/or an external power source, to the various parts of the UE 1800 via input circuitry or an interface such as an electrical power cable. Delivering power may be, for example, for charging of the power source 1808. Power circuitry may perform any formatting, converting, or other modification to the power from the power source 1808 to make the power suitable for the respective components of the UE 1800 to which power is supplied.

The memory 1810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1810 includes one or more application programs 1814, such as an operating system, web browser application, a widget, gadget engine, or other application, and corresponding data 1816. The memory 1810 may store, for use by the UE 1800, any of a variety of various operating systems or combinations of operating systems.

The memory 1810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1810 may allow the UE 1800 to access instructions, application programs and the like, stored on transitory or non-transitory memory media, to off-load data, or to upload data. An article of manufacture, such as one utilizing a communication system may be tangibly embodied as or in the memory 1810, which may be or comprise a device-readable storage medium.

The processing circuitry 1802 may be configured to communicate with an access network or other network using the communication interface 1812. The communication interface 1812 may comprise one or more communication subsystems and may include or be communicatively coupled to an antenna 1822. The communication interface 1812 may include one or more transceivers used to communicate, such as by communicating with one or more remote transceivers of another device capable of wireless communication (e.g., another UE or a network node in an access network). Each transceiver may include a transmitter 1818 and/or a receiver 1820 appropriate to provide network communications (e.g., optical, electrical, frequency allocations, and so forth). Moreover, the transmitter 1818 and receiver 1820 may be coupled to one or more antennas (e.g., antenna 1822) and may share circuit components, software or firmware, or alternatively be implemented separately.

In the illustrated embodiment, communication functions of the communication interface 1812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1800 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 19 shows a network node 1900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1900 includes a processing circuitry 1902, a memory 1904, a communication interface 1906, and a power source 1908. The network node 1900 may be composed of multiple physically separate components (e.g., a NodeB component and a RNC component, or a BTS component and a BSC component, etc.), which may each have their own respective components. In certain scenarios in which the network node 1900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1900 may be configured to support multiple radio access technologies (RATs). In such embodiments, some components may be duplicated (e.g., separate memory 1904 for different RATs) and some components may be reused (e.g., a same antenna 1910 may be shared by different RATs). The network node 1900 may also include multiple sets of the various illustrated components for different wireless technologies integrated into network node 1900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1900.

The processing circuitry 1902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1900 components, such as the memory 1904, to provide network node 1900 functionality.

In some embodiments, the processing circuitry 1902 includes a system on a chip (SOC). In some embodiments, the processing circuitry 1902 includes one or more of radio frequency (RF) transceiver circuitry 1912 and baseband processing circuitry 1914. In some embodiments, the radio frequency (RF) transceiver circuitry 1912 and the baseband processing circuitry 1914 may be on separate chips (or sets of chips), boards, or units, such as radio units and digital units. In alternative embodiments, part or all of RF transceiver circuitry 1912 and baseband processing circuitry 1914 may be on the same chip or set of chips, boards, or units.

The memory 1904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1902. The memory 1904 may store any suitable instructions, data, or information, including a computer program, software, an application including one or more of logic, rules, code, tables, and/or other instructions capable of being executed by the processing circuitry 1902 and utilized by the network node 1900. The memory 1904 may be used to store any calculations made by the processing circuitry 1902 and/or any data received via the communication interface 1906. In some embodiments, the processing circuitry 1902 and memory 1904 is integrated.

The communication interface 1906 is used in wired or wireless communication of signaling and/or data between a network node, access network, and/or UE. As illustrated, the communication interface 1906 comprises port(s)/terminal(s) 1916 to send and receive data, for example to and from a network over a wired connection. The communication interface 1906 also includes radio front-end circuitry 1918 that may be coupled to, or in certain embodiments a part of, the antenna 1910. Radio front-end circuitry 1918 comprises filters 1920 and amplifiers 1922. The radio front-end circuitry 1918 may be connected to an antenna 1910 and processing circuitry 1902. The radio front-end circuitry may be configured to condition signals communicated between antenna 1910 and processing circuitry 1902. The radio front-end circuitry 1918 may receive digital data that is to be sent out to other network nodes or UEs via a wireless connection. The radio front-end circuitry 1918 may convert the digital data into a radio signal having the appropriate channel and bandwidth parameters using a combination of filters 1920 and/or amplifiers 1922. The radio signal may then be transmitted via the antenna 1910. Similarly, when receiving data, the antenna 1910 may collect radio signals which are then converted into digital data by the radio front-end circuitry 1918. The digital data may be passed to the processing circuitry 1902. In other embodiments, the communication interface may comprise different components and/or different combinations of components.

In certain alternative embodiments, the network node 1900 does not include separate radio front-end circuitry 1918, instead, the processing circuitry 1902 includes radio front-end circuitry and is connected to the antenna 1910. Similarly, in some embodiments, all or some of the RF transceiver circuitry 1912 is part of the communication interface 1906. In still other embodiments, the communication interface 1906 includes one or more ports or terminals 1916, the radio front-end circuitry 1918, and the RF transceiver circuitry 1912, as part of a radio unit (not shown), and the communication interface 1906 communicates with the baseband processing circuitry 1914, which is part of a digital unit (not shown).

The antenna 1910 may include one or more antennas, or antenna arrays, configured to send and/or receive wireless signals. The antenna 1910 may be coupled to the radio front-end circuitry 1918 and may be any type of antenna capable of transmitting and receiving data and/or signals wirelessly. In certain embodiments, the antenna 1910 is separate from the network node 1900 and connectable to the network node 1900 through an interface or port.

The antenna 1910, communication interface 1906, and/or the processing circuitry 1902 may be configured to perform any receiving operations and/or certain obtaining operations described herein as being performed by the network node. Any information, data and/or signals may be received from a UE, another network node and/or any other network equipment. Similarly, the antenna 1910, the communication interface 1906, and/or the processing circuitry 1902 may be configured to perform any transmitting operations described herein as being performed by the network node. Any information, data and/or signals may be transmitted to a UE, another network node and/or any other network equipment.

The power source 1908 provides power to the various components of network node 1900 in a form suitable for the respective components (e.g., at a voltage and current level needed for each respective component). The power source 1908 may further comprise, or be coupled to, power management circuitry to supply the components of the network node 1900 with power for performing the functionality described herein. For example, the network node 1900 may be connectable to an external power source (e.g., the power grid, an electricity outlet) via an input circuitry or interface such as an electrical cable, whereby the external power source supplies power to power circuitry of the power source 1908. As a further example, the power source 1908 may comprise a source of power in the form of a battery or battery pack which is connected to, or integrated in, power circuitry. The battery may provide backup power should the external power source fail.

Embodiments of the network node 1900 may include additional components beyond those shown in FIG. 19 for providing certain aspects of the network node's functionality, including any of the functionality described herein and/or any functionality necessary to support the subject matter described herein. For example, the network node 1900 may include user interface equipment to allow input of information into the network node 1900 and to allow output of information from the network node 1900. This may allow a user to perform diagnostic, maintenance, repair, and other administrative functions for the network node 1900.

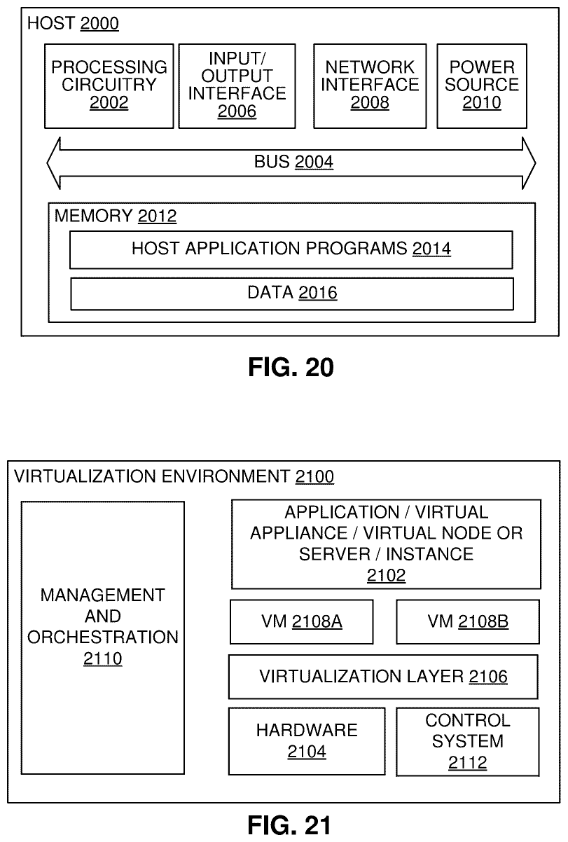

FIG. 20 is a block diagram of a host 2000, which may be an embodiment of the host 1716 of FIG. 17, in accordance with various aspects described herein. As used herein, the host 2000 may be or comprise various combinations hardware and/or software, including a standalone server, a blade server, a cloud-implemented server, a distributed server, a virtual machine, container, or processing resources in a server farm. The host 2000 may provide one or more services to one or more UEs.

The host 2000 includes processing circuitry 2002 that is operatively coupled via a bus 2004 to an input/output interface 2006, a network interface 2008, a power source 2010, and a memory 2012. Other components may be included in other embodiments. Features of these components may be substantially similar to those described with respect to the devices of previous figures, such as FIGS. 18 and 19, such that the descriptions thereof are generally applicable to the corresponding components of host 2000.

The memory 2012 may include one or more computer programs including one or more host application programs 2014 and data 2016, which may include user data, e.g., data generated by a UE for the host 2000 or data generated by the host 2000 for a UE. Embodiments of the host 2000 may utilize only a subset or all of the components shown. The host application programs 2014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2014 may also provide for user authentication and licensing checks and may periodically report health, routes, and content availability to a central node, such as a device in or on the edge of a core network. Accordingly, the host 2000 may select and/or indicate a different host for over-the-top services for a UE. The host application programs 2014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 21 is a block diagram illustrating a virtualization environment 2100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2106 (also referred to as hypervisors or virtual machine monitors (VMMs)), provide VMs 2108a and 2108b (one or more of which may be generally referred to as VMs 2108), and/or perform any of the functions, features and/or benefits described in relation with some embodiments described herein. The virtualization layer 2106 may present a virtual operating platform that appears like networking hardware to the VMs 2108.

The VMs 2108 comprise virtual processing, virtual memory, virtual networking or interface and virtual storage, and may be run by a corresponding virtualization layer 2106. Different embodiments of the instance of a virtual appliance 2102 may be implemented on one or more of VMs 2108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2108 may be a software implementation of a physical machine that runs programs as if they were executing on a physical, non-virtualized machine. Each of the VMs 2108, and that part of hardware 2104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2108 on top of the hardware 2104 and corresponds to the application 2102.

Hardware 2104 may be implemented in a standalone network node with generic or specific components. Hardware 2104 may implement some functions via virtualization. Alternatively, hardware 2104 may be part of a larger cluster of hardware (e.g. such as in a data center or CPE) where many hardware nodes work together and are managed via management and orchestration 2110, which, among others, oversees lifecycle management of applications 2102. In some embodiments, hardware 2104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2112 which may alternatively be used for communication between hardware nodes and radio units.

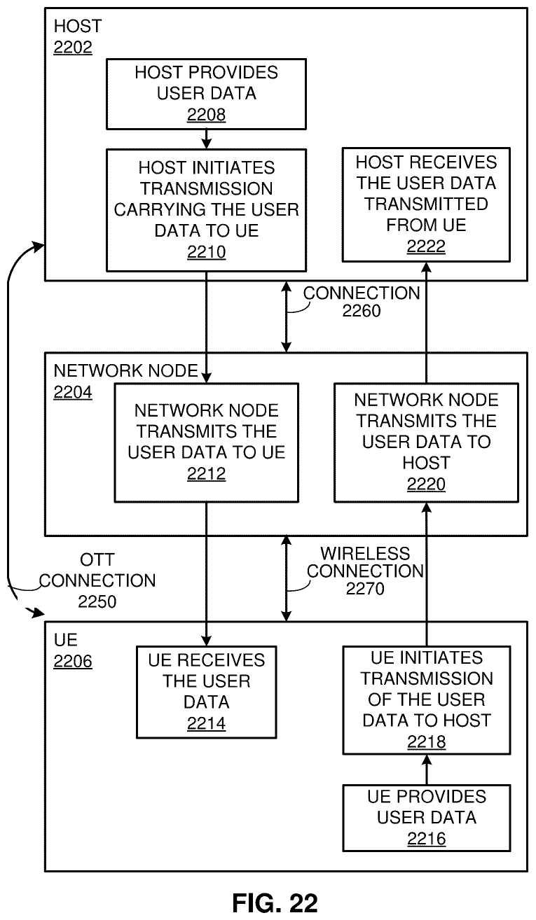

FIG. 22 shows a communication diagram of a host 2202 communicating via a network node 2204 with a UE 2206 over a partially wireless connection in accordance with some embodiments. Example implementations, in accordance with various embodiments, of the UE (such as a UE 1712a of FIG. 17 and/or UE 1800 of FIG. 18), network node (such as network node 1710a of FIG. 17 and/or network node 1900 of FIG. 19), and host (such as host 1716 of FIG. 17 and/or host 2000 of FIG. 20) discussed in the preceding paragraphs will now be described with reference to FIG. 22.

Like host 2000, embodiments of host 2202 include hardware, such as a communication interface, processing circuitry, and memory. The host 2202 also includes software, which is stored in or accessible by the host 2202 and executable by the processing circuitry. The software includes a host application that may be operable to provide a service to a remote user, such as the UE 2206 connecting via an over-the-top (OTT) connection 2250 extending between the UE 2206 and host 2202. In providing the service to the remote user, a host application may provide user data which is transmitted using the OTT connection 2250.

The network node 2204 includes hardware enabling it to communicate with the host 2202 and UE 2206. The connection 2260 may be direct or pass through a core network (like core network 1706 of FIG. 17) and/or one or more other intermediate networks, such as one or more public, private, or hosted networks. For example, an intermediate network may be a backbone network or the Internet.

The UE 2206 includes hardware and software, which is stored in or accessible by UE 2206 and executable by the UE's processing circuitry. The software includes a client application, such as a web browser or operator-specific “app” that may be operable to provide a service to a human or non-human user via UE 2206 with the support of the host 2202. In the host 2202, an executing host application may communicate with the executing client application via the OTT connection 2250 terminating at the UE 2206 and host 2202. In providing the service to the user, the UE's client application may receive request data from the host's host application and provide user data in response to the request data. The OTT connection 2250 may transfer both the request data and the user data. The UE's client application may interact with the user to generate the user data that it provides to the host application through the OTT connection 2250.

The OTT connection 2250 may extend via a connection 2260 between the host 2202 and the network node 2204 and via a wireless connection 2270 between the network node 2204 and the UE 2206 to provide the connection between the host 2202 and the UE 2206. The connection 2260 and wireless connection 2270, over which the OTT connection 2250 may be provided, have been drawn abstractly to illustrate the communication between the host 2202 and the UE 2206 via the network node 2204, without explicit reference to any intermediary devices and the precise routing of messages via these devices.

As an example of transmitting data via the OTT connection 2250, in step 2208, the host 2202 provides user data, which may be performed by executing a host application. In some embodiments, the user data is associated with a particular human user interacting with the UE 2206. In other embodiments, the user data is associated with a UE 2206 that shares data with the host 2202 without explicit human interaction. In step 2210, the host 2202 initiates a transmission carrying the user data towards the UE 2206. The host 2202 may initiate the transmission responsive to a request transmitted by the UE 2206. The request may be caused by human interaction with the UE 2206 or by operation of the client application executing on the UE 2206. The transmission may pass via the network node 2204, in accordance with the teachings of the embodiments described throughout this disclosure. Accordingly, in step 2212, the network node 2204 transmits to the UE 2206 the user data that was carried in the transmission that the host 2202 initiated, in accordance with the teachings of the embodiments described throughout this disclosure. In step 2214, the UE 2206 receives the user data carried in the transmission, which may be performed by a client application executed on the UE 2206 associated with the host application executed by the host 2202.

In some examples, the UE 2206 executes a client application which provides user data to the host 2202. The user data may be provided in reaction or response to the data received from the host 2202. Accordingly, in step 2216, the UE 2206 may provide user data, which may be performed by executing the client application. In providing the user data, the client application may further consider user input received from the user via an input/output interface of the UE 2206. Regardless of the specific manner in which the user data was provided, the UE 2206 initiates, in step 2218, transmission of the user data towards the host 2202 via the network node 2204. In step 2220, in accordance with the teachings of the embodiments described throughout this disclosure, the network node 2204 receives user data from the UE 2206 and initiates transmission of the received user data towards the host 2202. In step 2222, the host 2202 receives the user data carried in the transmission initiated by the UE 2206.

One or more of the various embodiments improve the performance of OTT services provided to the UE 2206 using the OTT connection 2250, in which the wireless connection 2270 forms the last segment. More precisely, the teachings of these embodiments may enable re-use of same encoding and decoding blocks (e.g., 66B, RS-FEC) of clients can reduce design complexity and add flexibility (e.g., ports can be configured as clients or lines). In some examples, the line rate can be the same or a higher than the client rate, which avoids the use of dedicated optical modules. In additional or alternative embodiments, direct mapping of client data on timeslots and proprietary idle sequences are used to adapt the client rate to the line rate. In some examples, the line rate can be the same or a higher than the client rate, which avoids the use of dedicated optical modules.

In an example scenario, factory status information may be collected and analyzed by the host 2202. As another example, the host 2202 may process audio and video data which may have been retrieved from a UE for use in creating maps. As another example, the host 2202 may collect and analyze real-time data to assist in controlling vehicle congestion (e.g., controlling traffic lights). As another example, the host 2202 may store surveillance video uploaded by a UE. As another example, the host 2202 may store or control access to media content such as video, audio, VR or AR which it can broadcast, multicast or unicast to UEs. As other examples, the host 2202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2250 between the host 2202 and UE 2206, in response to variations in the measurement results. The measurement procedure and/or the network functionality for reconfiguring the OTT connection may be implemented in software and hardware of the host 2202 and/or UE 2206. In some embodiments, sensors (not shown) may be deployed in or in association with other devices through which the OTT connection 2250 passes; the sensors may participate in the measurement procedure by supplying values of the monitored quantities exemplified above, or supplying values of other physical quantities from which software may compute or estimate the monitored quantities. The reconfiguring of the OTT connection 2250 may include message format, retransmission settings, preferred routing etc.; the reconfiguring need not directly alter the operation of the network node 2204. Such procedures and functionalities may be known and practiced in the art. In certain embodiments, measurements may involve proprietary UE signaling that facilitates measurements of throughput, propagation times, latency and the like, by the host 2202. The measurements may be implemented in that software causes messages to be transmitted, in particular empty or ‘dummy’ messages, using the OTT connection 2250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a transmitting node, the method comprising:
determining client data to be transmitted to a receiving node, the client data associated to a client, wherein determining the client data comprises compressing the client data;
determining a difference between a data rate of the client data and a portion of a total line rate, the total line rate being associated with a line between the transmitting node and the receiving node, and the portion of the total line rate being associated with the client;
generating a transmission signal by adding information to the client data, an amount of the information being based on the difference between the data rate and the portion of the total line rate; and
transmitting the transmission signal to the receiving node via the line.

2. (canceled)

3. The method of claim 1, wherein compressing the client data comprises performing Ethernet sequence compression to the client data.

4. The method of claim 3, wherein performing the Ethernet sequence compression comprises compressing at least one of:
a frame start indicator of the client data;
an idle frame of the client data;
a sequence ordered set of the client data; and
a repeating error sequence of the client data.

5. The method of claim 1, wherein the client data comprises at least one of:
an Ethernet client;
a Common Public Radio Interface, CPRI, client;
an Open Base Station Architecture Initiative, OBSAI, client;
a Synchronous Transfer Mode, STM, client;
a fiber channel, FC, client;
an Optical Transport Unit, OTU, client; and
an Agnostic Transport for Fronthaul, ATF, client.

6. The method of claim 1, wherein the information includes service channel information or overhead information.

7. The method of claim 1, wherein the amount of the information is less than or equal to the difference between the data rate and the portion of the total line rate.

8. The method of claim 1, wherein generating the transmission signal comprises:
framing the client data;
assigning client data to timeslots; and
adding the information in empty timeslots.

9. The method of claim 8, wherein generating the transmission signal comprises mapping 64 bits of client data on a data-only 66 Byte word.

10. The method of claim 1, wherein the client data comprises a plurality of client data multiplexed together.

11. A method of operating a receiving node, the method comprising:
receiving a received signal from a transmitting node via a line between the transmitting node and the receiving node;
extracting information from the received signal;
determining client data from the received signal, the client data being separate from the information, wherein determining the client data comprises decompressing the received signal; and
providing the client data to an associated client.

12. (canceled)

13. The method of claim 11, wherein decompressing the received signal comprises performing Ethernet sequence expansion to the received signal.

14. The method of claim 11, wherein the received signal comprises an Agnostic Transport for Fronthaul, ATF, 25 encoded signal.

15. The method of claim 11, wherein the client data comprises at least one of:
an Ethernet client;
a Common Public Radio Interface, CPRI, client;
an Open Base Station Architecture Initiative, OBSAI, client;
a Synchronous Transfer Mode, STM, client;
a fiber channel, FC, client;
an Optical Transport Unit, OTU, client; and
an Agnostic Transport for Fronthaul, ATF, client.

16. The method of claim 11, wherein the information includes service channel information or overhead information.

17. The method of claim 11, wherein determining the client data comprises demapping 64 bits of client data from a data-only 66 Byte word.

18.-26. (canceled)

27. A host configured to operate in a communication system to provide an over-the-top (OTT) service, the host comprising:
processing circuitry configured to provide user data, wherein the processing circuitry of the host is configured to execute a host application that provides the user data; and
a network interface configured to initiate transmission of the user data to a network node in a cellular network for transmission to a user equipment (UE) comprising processing circuitry configured to execute a client application associated with the host application to receive the transmission of user data from the host, the network node having a communication interface and processing circuitry, the processing circuitry of the network node configured to perform the following operations to transmit the user data from the host to the UE:
determining client data to be transmitted to a receiving node, the client data associated to a client;
determining a difference between a data rate of the client data and a portion of a total line rate, the total line rate being associated with a line between the transmitting node and the receiving node, and the portion of the total line rate being associated with the client;
generating a transmission signal by adding information to the client data, an amount of the information being based on the difference between the data rate and the portion of the total line rate; and
transmitting the transmission signal to the receiving node via the line.

28. (canceled)

29. A method implemented in a host configured to operate in a communication system that further includes a network node and a user equipment (UE), the method comprising:
providing user data for the UE, wherein the user data is provided at the host by executing a host application that interacts with a client application executing on the UE, the client application being associated with the host application; and
initiating a transmission carrying the user data to the UE via a cellular network comprising the network node, wherein the network node performs the following operations to transmit the user data from the host to the UE:
determining client data to be transmitted to a receiving node, the client data associated to a client;
determining a difference between a data rate of the client data and a portion of a total line rate, the total line rate being associated with a line between the transmitting node and the receiving node, and the portion of the total line rate being associated with the client;
generating a transmission signal by adding information to the client data, an amount of the information being based on the difference between the data rate and the portion of the total line rate; and
transmitting the transmission signal to the receiving node via the line.

30. (canceled)

31. (canceled)

32. A communication system configured to provide an over-the-top service, the communication system comprising:
a host comprising:
processing circuitry configured to provide user data for a user equipment (UE), the user data being associated with the over-the-top service, wherein the processing circuitry of the host is configured to execute a host application, thereby providing the user data, and the host application is configured to interact with a client application executing on the UE, the client application being associated with the host application; and
a network interface configured to initiate transmission of the user data toward a cellular network node for transmission to the UE, the network node having a communication interface and processing circuitry, the processing circuitry of the network node configured to perform the following operations to transmit the user data from the host to the UE:
determining client data to be transmitted to a receiving node, the client data associated to a client;
determining a difference between a data rate of the client data and a portion of a total line rate, the total line rate being associated with a line between the transmitting node and the receiving node, and the portion of the total line rate being associated with the client;
generating a transmission signal by adding information to the client data, an amount of the information being based on the difference between the data rate and the portion of the total line rate; and
transmitting the transmission signal to the receiving node via the line.

33.-34. (canceled)

35. A host configured to operate in a communication system to provide an over-the-top (OTT) service, the host comprising:
processing circuitry configured to initiate receipt of user data, wherein the processing circuitry of the host is configured to execute a host application, thereby providing the user data, and the host application is configured to interact with a client application executing on the UE, the client application being associated with the host application; and
a network interface configured to receive the user data from a network node in a cellular network, the network node having a communication interface and processing circuitry, the processing circuitry of the network node configured to perform the following operations to receive the user data from a user equipment (“UE”) for the host:
receiving a received signal from a transmitting node via a line between the transmitting node and a receiving node;
extracting information from the received signal;
determining client data from the received signal, the client data being separate from the information; and
providing the client data to an associated client.

36. (canceled)

37. The host of claim 35, wherein the initiating receipt of the user data comprises requesting the user data.

38.-39. (canceled)
